(19) United States
(12) Patent Application Publication
(10) Pub. No.: US 2009/0280669 A1
(43) Pub. Date: Nov. 12, 2009

(54) BUSBAR ASSEMBLY

(75) Inventors: Yin-Yuan Chen, Taoyuan Hsien (TW); Chen-Yu Yu, Taoyuan Hsien (TW)

Correspondence Address: KIRTON AND MCCONKIE, 60 EAST SOUTH TEMPLE,, SUITE 1800, SALT LAKE CITY, UT, 84111, US

(73) Assignee: DELTA ELECTRONICS, INC., Taoyuan Hsien (TW)

(21) Appl. No.: 12/435,022

(22) Filed: May 4, 2009

(30) Foreign Application Priority Data
May 6, 2008 (TW) 097116688

(51) Int. Cl. H01R 13/02; H01R 13/621

(52) U.S. Cl. 439/292

(57) ABSTRACT

A busbar assembly for conducting current is disclosed. The busbar assembly includes a first metal-extruded busbar having a first body and a first end-surface substantially vertical to an axis of the first body; a second metal-extruded busbar having a second body; and a connecting bar having a corresponding first end and a corresponding second end. The first end is buried to the first body of the first busbar and the second end extending from the first end-surface of the first metal-extruded busbar is buried to the second body of the metal-extruded busbar, whereby the first metal-extruded busbar is electrically connected to the second metal-extruded busbar through the connecting bar.

### FIELD OF THE INVENTION

The present invention relates to a busbar assembly, and more particularly to a busbar assembly constructed of a metal-extruded busbar.

### BACKGROUND OF THE INVENTION

Generally, the power supply system of large equipment, such as network apparatus, communication apparatus, telecommunication apparatus, uninterruptible power system (UPS), data center, uses busbar assembly to connect various electronic apparatuses for power distribution and transmission.

Generally, a busbar assembly is constructed by multiple copper busbars. Please refer to FIG. 1 which is a partial view illustrating a conventional busbar assembly. As shown in FIG. 1, a conventional busbar assembly 10 at least includes a first copper busbar 11, a second copper busbar 12 and a third copper busbar 13, which are multiple bar-shaped conductive metal strips formed by directly cutting the copper plate. As shown in FIG. 1, the second copper busbar 12 is partially contacted to the first copper busbar 11 and the third copper busbar 13, respectively. The overlap between the first copper busbar 11 and the second copper busbar 12 is engaged by a screw 14 and a nut 15 from Z-axial, which is vertical to the X-axial of the first and second copper busbars 11 and 12, for forming electricity connection. Similarly, the third copper busbar 13 is vertically contacted to the second copper busbar 12 and the overlap therebetween is engaged by screwing as the above description for forming electricity connection. Hence, the electricity connection is formed among the first copper busbar 11, the second copper busbar 12 and the third copper busbar 13. Using the different connecting types among the first, second and third copper busbars 11, 12 and 13, the conventional busbar assembly 10 is co-operated with the base of the large equipment (not shown in FIG. 1) to dispose for transmitting electric power to individual electronic apparatuses (not shown in FIG. 1) through the first, second and third copper busbars 11, 12 and 13.

Since the above copper busbars 11, 12 and 13 are formed by cutting the copper plate, the lengths and shapes thereof are limited to the shape of the copper plate. Therefore, the disposition of the conventional copper busbars is hard to change without restriction. In other word, the disposition among the copper busbars 11, 12 and 13 is less flexibility. In addition, because the electricity connection is formed by attaching the surfaces among the copper busbars 11, 12 and 13. However, the surfaces of them are usually rugged and cannot stick together without any space within. Therefore, the overlap contact surfaces between the first and second copper busbars 11 and 12 or the second and third copper busbars 12 and 13 easily form a clearance 16. The clearance 16 not only affects the conductive effect of the busbar assembly 10, but also increases the contact impedance of the overlap while electric current passes through the contact surfaces. Furthermore, the fixing by the screw 14 and the nut 15 could be loose. Hence, once the fixing between the first and second copper busbars 11 and 12 or the second and third copper busbars 12 and 13 is not tight enough, the clearance 16 will increase to result in the increase of contact impedance, or the separation will occur therebetween to cause electricity disconnection. All those affect the operation efficiency and function of the busbar assembly 10.

Moreover, the busbar assembly 10 is used for conducting large current, so it will produce a lot of heat while current conduction. Furthermore, since the shapes of the copper busbars 11-13 is hard to change as mentioned above, the size of the conventional busbar assembly 10 must be increased or the additional heat-dissipating device (not shown in FIG. 1) disposed on the copper busbars 11-13 is necessary to enhance the heat-dissipating efficiency, in order to solve heat-dissipating issue and conform to the safety specification. However, the copper plate is costly. Therefore, the manufacture cost will be increased no matter the area of the copper busbars 11-13 is enlarged or the heat-dissipating device is added.

Therefore, the purpose of the present invention is to develop a busbar assembly to deal with the above situations encountered in the prior art.

### SUMMARY OF THE INVENTION

An object of the present invention is to provide a busbar assembly using a metal-extruded busbar to replace the conventional copper busbar and the ends of a connecting bar to engage to plural metal-extruded busbars for achieving the electrical connection thereamong through the connecting bar.

Another object of the present invention is to provide a busbar assembly for avoiding the contact impedance resulting from the clearance between the unsmooth contact surfaces of the conventional copper busbars to assure the operation efficiency of the busbar assembly.

An additional object of the present invention is to provide a busbar assembly for increasing the disposition flexibility, enhancing the heat-dissipating efficiency and lowering the cost.

According to an aspect of the present invention, there is provided a busbar assembly for conducting current. The busbar assembly includes a first metal-extruded busbar having a first body and a first end-surface substantially vertical to an axis of the first body; a second metal-extruded busbar having a second body; and a connecting bar having a corresponding first end and a corresponding second end. The first end is buried to the first body of the first busbar and the second end extending from the first end-surface of the first metal-extruded busbar is buried to the second body of the metal-extruded busbar, whereby the first metal-extruded busbar is electrically connected to the second metal-extruded busbar through the connecting bar.

Preferably, the first metal-extruded busbar includes a first heat-dissipating element disposed on at least partial the first body, and the second metal-extruded busbar includes a second heat-dissipating element disposed on at least partial the second body. Preferably, the first heat-dissipating element is integrally formed with the first body, and the second heat-dissipating element is integrally formed with the second body. Preferably, the first and second heat-dissipating elements are heat-dissipating fins.

Preferably, the first and second ends of the connecting bar have thread thereon. Preferably, the first body of the first metal-extruded busbar includes a first accommodated space disposed from the first end-surface along the axis of the first body. Preferably, the first accommodated space has thread disposed on the wall thereof, whereby screwing the first end of the connecting bar into the first accommodated space. Preferably, the first accommodated space passes through the first body.

Preferably, the second body of the second metal-extruded busbar includes a second accommodated space disposed thread on the wall thereof, whereby screwing the second end of the connecting bar into the second accommodated space. Preferably, the second accommodated space disposed from a second end-surface along the axis of the second body, and the second end-surface is substantially vertical to the axis of second body. Preferably, the second accommodated space passes through the second body.

Preferably, the second accommodated space is disposed in the second body and has an extending direction substantially vertical to the axis of the second body.

Preferably, the first body of first metal-extruded busbar is positioned to the first end of the connecting bar by a first fastening element, and the second body of second metal-extruded busbar is positioned to the second end of the connecting bar by a second fastening element.

Preferably, the first and second ends of the connecting bar are substantially parallel to each other.

Preferably, the first and second ends of the connecting bar are substantially vertical to each other.

Preferably, the connecting bar is integrally formed with the first body of the first metal-extruded busbar.

Preferably, the first and second metal-extruded busbars are aluminum-extruded busbars.

### BRIEF DESCRIPTION OF THE DRAWINGS

The present invention may best be understood through the following description with reference to the accompanying drawings, in which:

FIG. 1 is a partial view illustrating a conventional busbar assembly;

FIG. 2A is an exploded schematic diagram illustrating a preferred embodiment of a busbar assembly according to the present invention;

FIG. 2B is a composed sectional view of FIG. 2A;

FIG. 3A is an exploded schematic diagram illustrating another preferred embodiment of a busbar assembly according to the present invention;

FIG. 3B is a composed sectional view of FIG. 3A;

FIG. 4A is an exploded schematic diagram illustrating another preferred embodiment of a busbar assembly according to the present invention;

FIG. 4B is a composed sectional view of FIG. 4A;

FIG. 5A is an exploded schematic diagram illustrating a further preferred embodiment of a busbar assembly according to the present invention; and

FIG. 5B is a composed sectional view of FIG. 5A.

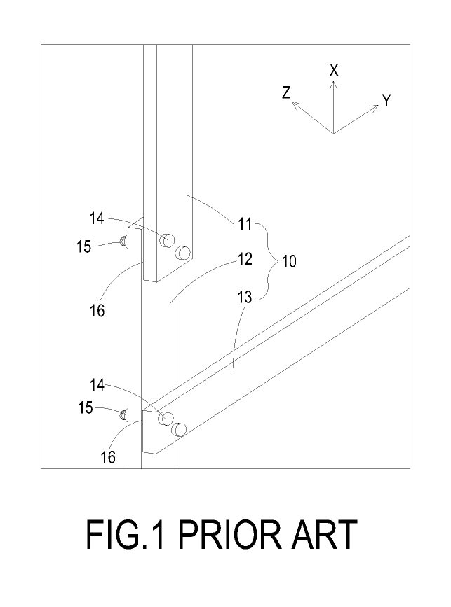

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

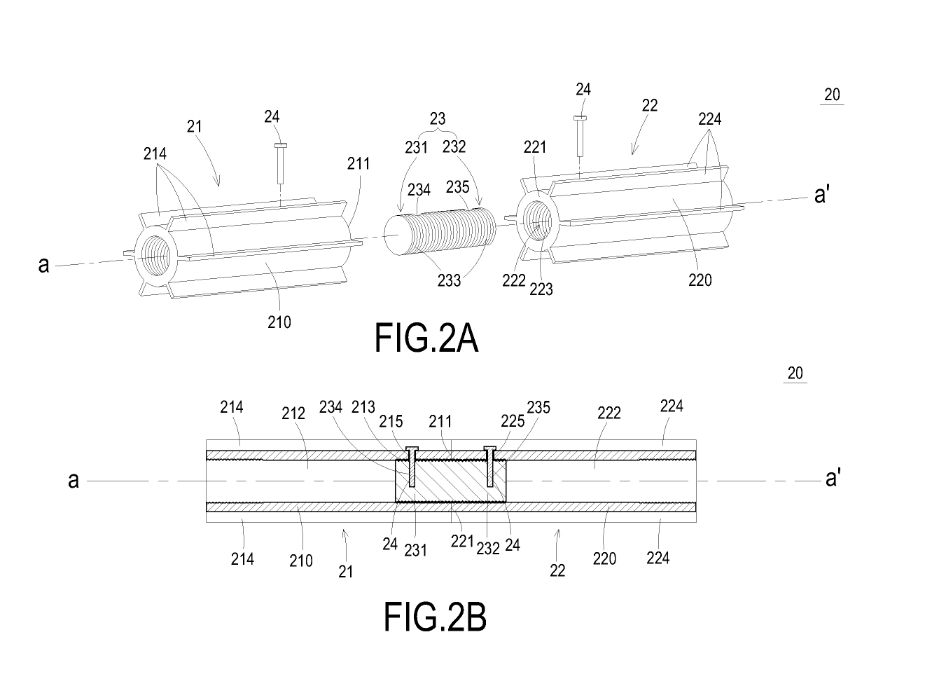

FIG. 2A is an exploded schematic diagram illustrating a preferred embodiment of a busbar assembly according to the present invention; and FIG. 2B is a composed sectional view of FIG. 2A. As shown in FIGS. 2A and 2B, a busbar assembly 20 at least includes a first metal-extruded busbar 21, a second metal-extruded busbar 22, and a connecting bar 23, which connects the first metal-extruded busbar 21 to the second metal-extruded busbar 22. The first metal-extruded busbar 21 includes a first body 210, a first accommodated space 212 and a first heat-dissipating element 214. The first body 210 has a first end-surface 211 at one end. As shown in FIG. 2A, the first end surface 211 is substantially vertical to the axis a of the first body 210, and corresponding to a first end 231 of the connecting bar 23. In addition, the first body 210 includes a first accommodated space 212 for accommodating the first end 231 of the connecting bar 23. The accommodated space 212 is disposed from the first end-surface 211 to the inside of the first body 210 along axis a. As shown in this preferred embodiment, the first body 210 is passed through by the first accommodated space 212. That is, the first body 210 is a hollow tube. Furthermore, the internal wall of the hollow tube near the first end-surface 211 has thread 213 disposed thereon (as shown in FIG. 2B), for engaging with the connecting bar 23. The busbar assembly 20 will generate a lot of heat when electric current is conduction. Hence, at least partial surface of the first body 210 of the first metal-extruded busbar 21 is disposed a first heat-dissipating element 214, such as heat-dissipating fin, to increase the whole surface area of the first metal-extruded busbar 21 for achieving the purpose of enhancing heat-dissipating effect.

In the preferred embodiment of FIGS. 2A and 2B, the first body 210, the first accommodated space 212 and first heat-dissipating element 214 of the first metal-extruded busbar 21 are preferably integrally formed, but it is not limited thereto. In addition, the first metal-extruded busbar 21 can be made of the material with both good malleability and conduction, such as aluminum . . . and so on. The first metal-extruded busbar 21 is formed by extruding metal through the extrusion mold (not shown in FIGS. 2A and 2B). In other words, the first metal-extruded busbar 21 can be the aluminum busbar. Moreover, the tread 213 can be formed by milling process, but it is not be limited thereto.

The structure of the second metal-extruded busbar 22 is similar to that of the first metal-extruded busbar 21. As shown in FIG. 2A, the second metal-extruded busbar 22 includes a second body 220, a second end-surface 221, a second accommodated space 222, a tread 223 and a second heat-dissipating element 224. The second end-surface 221 is substantially vertical to the axis a′ of the second body 220. The second accommodated space 222 passes through the second body 220 from the second end-surface 221 along the axis a′ of the second body 220 to form a hollow tube for accommodating the second end 232 of the connecting bar 23. As shown in FIG. 2B, the tread 223 is formed on the inside wall of the hollow tube and near the second end-surface 221. The second heat-dissipating element 224, such as heat-dissipating fin, is disposed on at least the partial surface of the second body 220 (as shown in FIG. 2A). In this preferred embodiment, the second metal-extruded busbar 22 can be made of the same material and formed by the same process as those of first metal-extruded busbar 21. That is, the second metal-extruded busbar 22 can be the aluminum busbar, too, but it is not limited thereto. Similarly, the individual structures of the second metal-extruded busbar 22 are preferably integrally formed, but it is not limited thereto.

Please refer to FIGS. 2A and 2B. The connecting bar 23, including the first and second ends 231 and 232, is made of conductive material, such as metal. In this preferred embodiment, the first end 231 is substantially parallel and coaxial to the second end 232 each other. In other words, the included angle between the first and second ends 231 and 232 is around 180 degree, resulting in the connecting bar 23 is the shape of a straight line. In addition, the outer diameter of the first and second ends 231 and 232 of the connecting bar 23 are around equal to the inside diameter of the first and second accommodated spaces 212 and 222, respectively. Furthermore, both the first and second ends 231 and 232 are disposed the threads 233, which are matched up to the thread 213 of the first accommodated space 212 and thread 223 of the second accommodated space 222, respectively. Hence, the connecting bar 23 is engaged to the first body 210 of the first metal-extruded busbar 21 by screwing the first end 231 into the first accommodated space 212 of the first body 210 via the treads 233 and 213. Therefore, the first end 231 can be fixed within the first accommodated space 212 for covering up the first end 231 within the first body 210. Simultaneously, the second end 232 of the connecting bar 23 is screwed into the second accommodated space 222 of the second body 220 by the threads 233 and 223 for fixing the second end 232 within the second accommodated space 222. That is, the second bar 232 is disposed within the second body 220 of the second metal-extruded busbar 22, whereby the first metal-extruded busbar 21 is electrically connected to the second metal-extruded busbar 22 through the connecting bar 23 as an engaging medium.

As shown in FIG. 2A, for assuring the structural strength of the busbar assembly 20, the first body 210 of the first metal-extruded busbar 21 is further disposed a hole 215 which is vertical to the axis a. Simultaneously, the first end 231 of the connecting bar 23 is disposed a corresponding hole 234. Hence, when the first end 231 of the connecting bar 23 is screwed into the first accommodated space 212, it only needs to align the hole 215 of the first body 210 and the hole 234 of the connecting bar 23 and then use a fastening element 24 to pass through the holes 215 and 234, for positioning the first end 231 of the connecting bar 23 to the first body 210 and for assuring the stably engagement between the first end 231 of the connecting bar 23 and the first body 210 of the first metal-extruded busbar 21. In addition, as shown in FIG. 2B, the screwing depth of the first end 231 of the connecting bar 23 can be confirmed by using the alignment of the holes 215 and 234. The fastening element 24 can be a bolt or a screw, but it is not limited thereto. Similarly, the second body 220 of the second metal-extruded busbar 22 and the second end 232 of the connecting bar 23 can be positioned and enhanced the connection structure by aligning the holes 225 and 235 and by using the fastening element 24. Accordingly, it can be avoided that the loose among the first and second metal-extruded busbars 21 and 22 and the connecting bar 23 because of a long time operation. Therefore, using the conductive route among the first and second metal-extruded busbars 21 and 22 and the connecting bar 23, the busbar assembly 20 certainly can conduct the electric current.

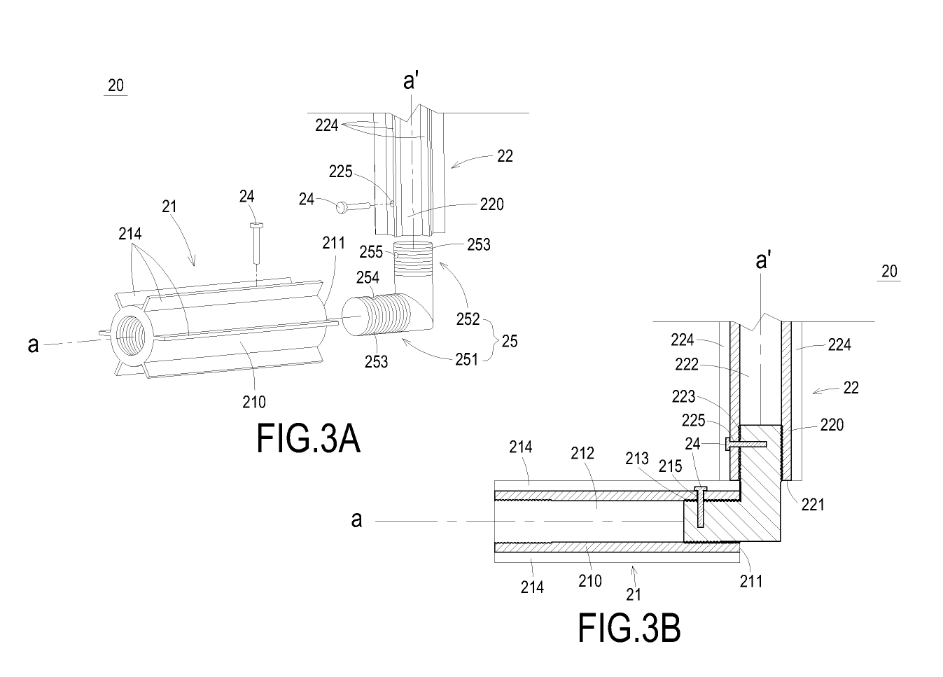

For co-operating with the base of the large equipment, the busbar assembly of the present invention has alternative modes to change the disposed direction. FIGS. 3A and 3B are an exploded schematic diagram and a composed sectional view illustrating another preferred embodiment of a busbar assembly according to the present invention. As shown in FIG. 3A, a busbar assembly 20 at least includes a first metal-extruded busbar 21, a second metal-extruded busbar 22 and a connecting bar 25. The structures of the first and second metal-extruded busbars 21 and 22 are similar to those of the preferred embodiment as shown in FIGS. 2A and 2B. So, it is unnecessary to be redundantly described herein. However, in this preferred embodiment, the connecting bar 25 is alternative. As shown in FIGS. 3A and 3B, the connecting bar 25 includes a first end 251 and a second end 252, wherein the first end 251 is substantially vertical to the second end 252 each other. In other words, the included angle between the first end 251 and the second end 252 is about 90 degree, resulting in that the connecting bar 25 presents an “L” shape, but it is not limited thereto. Furthermore, both the first and second ends 251 and 252 are disposed threads 253 thereon, and can additionally have holes 254 and 255, respectively. The connection way among the connecting bar 25, the first metal-extruded busbar 21 and the second metal-extruded busbar 22 and the position way via the fastening element 24 are similar to those of the preferred embodiment as shown in FIGS. 2A and 2B, so it is unnecessary to be redundantly described herein.

As shown in FIG. 3B, when the first end 251 and the second end 252 of the connecting bar 25 are screwed and fixed to the first metal-extruded busbar 21 and the second metal-extruded busbar 22, respectively, not only the electrical connection is formed between the first and second metal-extruded busbars 21 and 22 via the connecting bar 25 but also the directions of the first and second metal-extruded busbars 21 and 22 can be adjusted by changing the degree of the included angle between the first and second ends 251 and 252 of the connecting bar 25. Therefore, the metal-extruded busbar 20 can have various disposed alternatives to co-operate the base of the large equipment (not shown in FIGS. 3A and 3B).

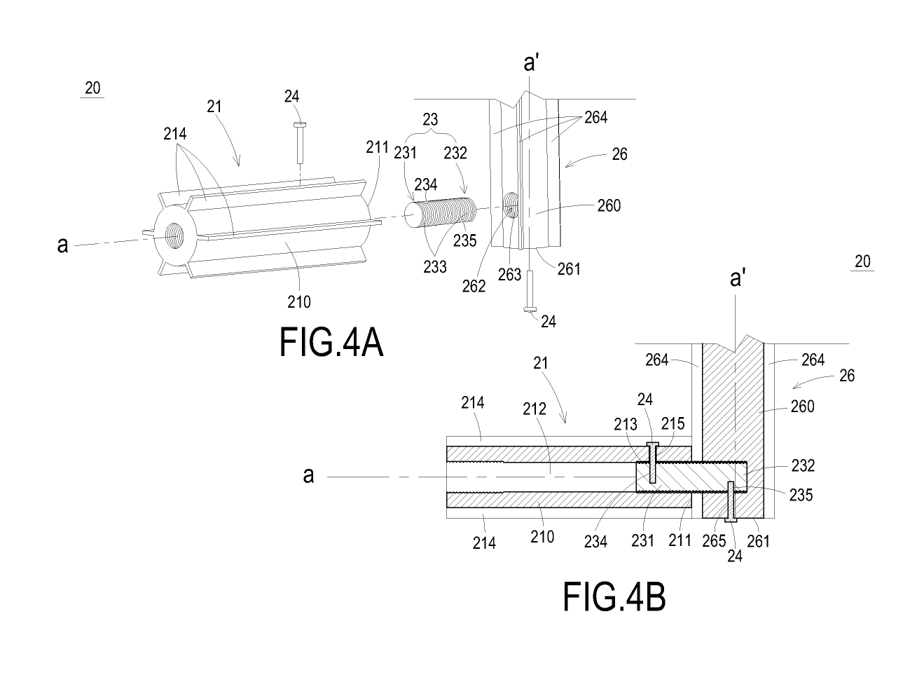

FIGS. 4A and 4B are an exploded schematic diagram and a composed sectional view illustrating another preferred embodiment of a busbar assembly according to the present invention, respectively. The busbar assembly 20 at least includes a first metal-extruded busbar 21, a second metal-extruded busbar 26 and a connecting bar 23. The structures of the first metal-extruded busbar 21 and the connecting bar 23 in this preferred embodiment are similar to those of the preferred embodiment as shown in FIGS. 2A and 2B. The second metal-extruded busbar 26 also includes the similar structures of a second body 260, a second end-surface 261 which is vertical to the axis a′ of the second body 260, a second accommodated space 262 and a second heat-dissipating element 264 as those of the preferred embodiment as shown in FIGS. 2A and 2B. However, as shown in FIG. 4A, the second body 260, which is a solid cylinder extruded by the mold, is integrally formed with the second heat-dissipating element 264, and the second accommodated space 262 is substantially vertical to the axis a′ to extend to the inside of the second body 260 from the surface of the second body 260 which is parallel to the axis a′. The internal wall of the second accommodated space 262 is disposed threads 263 thereon, for screwing and fixing to the second end 232 of the connecting bar 23.

Please refer to FIGS. 4A and 4B. The second end-surface 261 of the second body 260 can be additionally disposed a hole 265 parallel to the axis a′ thereon and the connecting bar 23 also can disposed holes 234 and 235 thereon for corresponding to the hole 215 of the first body 210 and hole 265 of the second body 260. As shown in FIG. 4B, when the holes 234, 235 and 215, 265 are aligned respectively, the connecting bar 23, the second body 260 and the first body 210 can be fixed by the fastening element 24. Therefore, the disposed direction of the busbar assembly 20 also can be changed by vertically disposing the second accommodated space 262 of the second metal-extruded busbar 26 to the axis a′ of the second body 260 and co-operating with the connecting bar 23 having parallel the first and second ends 231 and 232 (a shape of straight line).

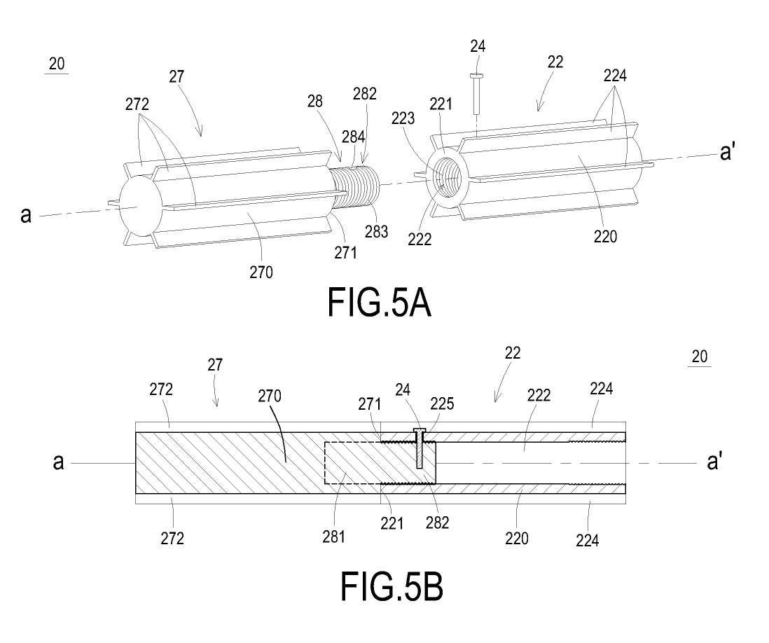

FIGS. 5A and 5B are an exploded schematic diagram and a composed sectional view illustrating a further preferred embodiment of a busbar assembly according to the present invention; respectively. As shown in FIGS. 5A and 5B, a busbar assembly 20 at least includes a first metal-extruded busbar 27, a second metal-extruded busbar 22 and a connecting bar 28. The first metal-extruded busbar 27 includes a first body 270, a first end-surface 271 which is vertical to the axis a of the first body 270, and a first heat-dissipating element 272, wherein the first body 270 is integrally formed with the connecting bar 28, preferably. In other words, the first body 270 and the connecting bar 28 of the first metal-extruded busbar 27 are integrally formed by extruding from the extrusion mold (not shown in FIGS. 5A and 5B), and cutting to form the first end-surface 271 and a second end 282. The second end 282 is extended form the first end-surface 271, and the connecting bar 28 has threads 283 thereon. Moreover, the second metal-extruded busbar 22 includes a second body 220, a second end-surface 221, a second accommodated space 222, threads 223 and a second heat-dissipating element 224. The structures of the second metal-extruded busbar 22 in this preferred embodiment are similar to those of the preferred embodiment of FIGS. 2A and 2B, so it is unnecessary to be redundantly described herein. Since the connecting bar 28 is integrally formed with the first body 270 of the first metal-extruded busbar 27 and is protruded from the first end-surface 271 of the second body 270, it only need to screw the second end 282 into the second accommodated space 222 of the second body 220 by the threads 283 and 223. Thus, the first metal-extruded busbar 27 is electrically connected to the second metal-extruded busbar 22 through the connecting bar 28. Certainly, the second end 282 of the connecting bar 28 can have a hole 284 for corresponding to the hole 225 of the second body 220 (as shown in FIG. 5B). Therefore, after the second end 282 is screwed into the second accommodated space 222, the connecting bar 28 can be positioned corresponding to the second metal-extruded busbar 22 by using a fastening element 24 to pass through the holes 225 and 284 for enhancing the structure of the busbar assembly 20.

Certainly, it should be understood that those preferred embodiments of the present invention are illustrated by using two metal-extruded busbars and one connecting bar to dispose the busbar assembly, but substantially the number of the metal-extruded busbar and the connecting bar of one busbar assembly is not limited thereto. In other words, in each preferred embodiment, the other ends of the first and second metal-extruded busbars corresponding to the first and second end-surface, respectively, can be further collocated to another connecting bar for electrically connecting to the third and fourth metal-extruded busbars to expand and vary the busbar assembly. For example, the busbar assembly can be expanded by using the preferred embodiments as shown in FIGS. 2A and 5A, or the disposed direction of the busbar assembly can be changed by collocating to the preferred embodiments as shown in FIGS. 3A and 4A for co-operating with the base of the large equipment. Certainly, the connecting bar can be further disposed a third end to bury into a third metal-extruded busbar, resulting in the branch disposition of the busbar assembly.

In addition, the metal-extruded busbar of the present invention can be a hollow tube extruded by the mold and carved thread on the screwing portion thereof as the first and second metal-extruded busbars shown in FIGS. 2B and 3B. The metal-extruded busbar, however, can also be a solid structure extruded by mold and then to form the accommodated space and carved thread thereof as the second metal-extruded busbar shown in FIG. 4B. The body of the metal-extruded busbar is the shape of a tube or a cylinder, but the shape of the metal-extruded busbar is not limited due to that all they are made by extruding the material having electric conductivity and malleability. In other words, the length and shape of the metal-extruded busbar can be adjusted by changing the extrusion mold. Similarly, the number and shape of the heat-dissipating element on the metal-extruded busbar can be optionally varied.

The material to make the metal-extruded busbar of the present invention can be a metal having excellent electric conductivity and malleability, such as aluminum, for easily extrusion process. Since aluminum will become non-conductive aluminum oxide after oxidation, if all the first and second metal-extruded busbars and the connecting bar are made of aluminum, the only thing need be done is to locally electroplate the engaged parts thereof. That is, the threads of the first and second accommodated spaces and the first and second ends of the connecting bar are electroplated, such as nickel-plating, for assuring the busbar assembly maintaining excellent conductivity.

Moreover, the contact area between the metal-extruded busbar and the connecting bar in the present invention can be optionally adjusted by changing the screw depth or the thread spacing of the end of the connecting bar and the accommodated space of the metal-extruded busbar.

To sum up, the busbar assembly according to the present invention includes the metal-extruded busbars and the connecting bar, wherein the shape of the metal-extruded busbars can be changed by adjusting the mold, the length thereof also can be optionally increased or shortened, and the connecting bar collocating thereto can have different types. Therefore, in comparison with the conventional busbar assembly whose copper busbars' shapes are limited because of the shape of copper plate and fixing method is only via the screw and the bit, the busbar assembly according to the present invention has more flexible disposition and more various disposition types. Furthermore, the metal-extruded busbars of the busbar assembly according to the present invention is integrally formed with the heat-dissipating element, so the heat-dissipating area thereof can be increased, which conduces to enhancing the heat-dissipating efficiency of the busbar assembly.

In addition, using that the two ends of the connecting bar in the present invention are buried and fixed in the bodies of the two metal-extruded busbars, respectively, the purpose of the electrical connection between the two metal-extruded busbars can be achieved through the connecting bar. In that way, not only the contact area between the connecting bar and the metal-extruded busbar can be optionally determined by adjusting the screwing depth or the thread spacing, but also the contact impedance resulting from the clearance between the copper busbars of the conventional busbar assembly can be assuredly avoided. Thus, the busbar assembly according to the present invention is able to conduct electric current more evenly, whereby maintaining the operation efficiency of the busbar assembly. Moreover, the screwing and fixing way between the connecting bar and the metal-extruded busbar in the present invention can simultaneously co-operate with the fastening element to position the metal-extruded busbar and the connecting bar, for further prevent the busbar assembly from loosing due to long time use.

Moreover, for assuring the busbar assembly in the present invention has excellent conductive effect, the simple thing should do is to electroplate the junction portion between the metal-extruded busbar and the connecting bar while the metal-extruded busbar is made of aluminum. In comparison with the conventional busbar assembly consisted of the expensive copper busbar, the busbar assembly of the present invention can not only lower the cost, but also decrease the weight of the busbar assembly because the density of aluminum is far smaller than that of copper. Furthermore, the insulation film will be formed on the surface of the busbar assembly in the present invention while the aluminum is oxidation, so it can be prevented the user from the danger of accidental touching the busbar assembly while the current is transmitted. Thus, comparing to the conventional busbar assembly consisted of the copper busbars, the busbar assembly according to the present invention includes many advantages which can not be achieved by the prior art.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A busbar assembly for conducting current, comprising:
a first metal-extruded busbar having a first body and a first end-surface substantially vertical to an axis of said first body;
a second metal-extruded busbar having a second body; and
a connecting bar having a corresponding first end and a corresponding second end, wherein said first end is buried to said first body of said first busbar and said second end extending from said first end-surface of said first metal-extruded busbar is buried to said second body of said metal-extruded busbar, whereby said first metal-extruded busbar is electrically connected to said second metal-extruded busbar through said connecting bar.

2. The busbar assembly according to claim 1 wherein said first metal-extruded busbar includes a first heat-dissipating element disposed on at least partial said first body, and said second metal-extruded busbar includes a second heat-dissipating element disposed on at least partial said second body.

3. The busbar assembly according to claim 2 wherein said first heat-dissipating element is integrally formed with said first body, and said second heat-dissipating element is integrally formed with said second body.

4. The busbar assembly according to claim 2 wherein said first and second heat-dissipating elements are heat-dissipating fins.

5. The busbar assembly according to claim 1 wherein said first and second ends of said connecting bar have thread thereon.

6. The busbar assembly according to claim 5 wherein said first body of said first metal-extruded busbar includes a first accommodated space disposed from said first end-surface along said axis of said first body.

7. The busbar assembly according to claim 6 wherein said first accommodated space has thread disposed on the surface thereof, whereby screwing said first end of said connecting bar into said first accommodated space.

8. The busbar assembly according to claim 6 wherein said first accommodated space passes through said first body.

9. The busbar assembly according to claim 5 wherein said second body of said second metal-extruded busbar includes a second accommodated space disposed thread thereon, whereby screwing said second end of said connecting bar into said second accommodated space.

10. The busbar assembly according to claim 9 wherein said second accommodated space disposed from a second end-surface along an axis of said second body, and said second end-surface is substantially vertical to said axis of second body.

11. The busbar assembly according to claim 10 wherein said second accommodated space passes through said second body.

12. The busbar assembly according to claim 9 wherein said second accommodated space is disposed in said second body and has an extending direction substantially vertical to said axis of said second body.

13. The busbar assembly according to claim 1 wherein said first body of first metal-extruded busbar is positioned to said first end of said connecting bar by a first fastening element, and said second body of second metal-extruded busbar is positioned to said second end of said connecting bar by a second fastening element.

14. The busbar assembly according to claim 1 wherein said first and second ends of said connecting bar are substantially parallel to each other.

15. The busbar assembly according to claim 1 wherein said first and second ends of said connecting bar are substantially vertical to each other.

16. The busbar assembly according to claim 1 wherein said connecting bar is integrally formed with said first body of said first metal-extruded busbar.

17. The busbar assembly according to claim 1 wherein said first and second metal-extruded busbars are aluminum-extruded busbars.
